(19) United States
(12) Patent Application Publication
(10) Pub. No.: US 2026/0152135 A1
(43) Pub. Date: Jun. 4, 2026

(54) POWER SYSTEM FOR ELECTRIC OR PARTIALLY-ELECTRIC MACHINES OR VEHICLES

(71) Applicant: Caterpillar Inc., Peoria, IL (US)

(72) Inventors: Nathaniel S. DOY, Clayton, NC (US); Craig P. HITTLE, Dunlap, IL (US); Thomas W. CARLILL, Tinwell (GB); John M. TANNER, Dunlap, IL (US); Jacob LESSEN, Washington, IL (US); Noah GEORGE, Brimfield, IL (US)

(73) Assignee: Caterpillar Inc., Peoria, IL (US)

(21) Appl. No.: 18/965,355

(22) Filed: Dec. 2, 2024

(51) Int. Cl. B60R 16/033; B60K 1/04; B60L 1/00; B60L 50/75; H02J 7/00

(52) U.S. Cl. CPC B60R 16/033; B60K 1/04; B60L 1/003; B60L 50/75; H02J 7/50; H02J 7/855; B60K 2001/0416; B60L 2200/40

(57) ABSTRACT

A power system for electric or partially-electric machines or vehicles is described herein. The disclosure includes a fully or partially-electric machine including a machine body and a power system. The machine body includes an engine cavity, and the power system is positioned within the engine cavity. The power system includes a power distribution unit (PDU), one or more batteries, a secondary power source, and one or more motors including a motor. The motor is configured to be operably connected to one or more components of the machine. The PDU is electrically connected to each of the one or more batteries, the secondary power source, and the first motor. The PDU is configured to receive power from one or more of the secondary power source or the one or more batteries and provide power to one or more of the motor or the one or more batteries.

### TECHNICAL FIELD

The present disclosure relates generally to electric or partially-electric machines or vehicles, and more particularly, to a power system for electric or partially-electric machines or vehicles.

### BACKGROUND

Industrial vehicles or machines, for example, wheel loaders, excavators, trucks (e.g., dump trucks, haul trucks, articulated dump trucks, etc.), track-type tractors (e.g., bulldozers), graders, continuous miners, feeder breakers, roof bolters, utility vehicles for mining, load-haul-dump (LHD) vehicles, underground mining loaders, underground articulated trucks, etc., may be fully electric, semi-electric, and non-electric. Electric and semi-electric (e.g., partially-electric) vehicles include one or more batteries, and non-electric vehicles can be retrofitted or upgraded to include one or more batteries. The one or more batteries include various connections (e.g., electrical connections) in order to power one or more motors, heating or cooling systems, hydraulic system(s), navigation systems, lighting systems, electronics, auxiliary systems, etc. However, during operation of an electric or semi-electric vehicle, the one or more batteries may discharge (e.g., run out of stored charge) and may require recharging.

U.S. Patent Publication No. 20240217350A1, by Laws et al., published on Jul. 4, 2024 (“the '350 publication”), describes a battery electric excavator. In particular, the '350 publication discloses a battery electric excavator with a main frame pivotable about a vertical pivot axis relative to an undercarriage. At least one high voltage battery is located on the main frame rearward of the vertical pivot axis and the operator's cabin. The '350 publication explains that the batteries are placed in a central location in machine as far as possible from the pivot axis. A power supply system of the electric excavator includes the high voltage batteries, which provide power to a high voltage bus. The '350 publication further discloses an onboard charger to provide power to the high voltage bus and the batteries. However, '350 publication lacks the capability to charge the high voltage batteries without being connected to a power grid. Further, the location or mounting of the batteries may present challenges during machine operation, for example, with the batteries or other machine components being susceptible to vibrations, twisting, impact, etc.

The systems, devices, and methods of the present disclosure may address or solve the problems set forth above or other problems in the art. The scope of the current disclosure, however, is defined by the attached claims, and not by the ability to solve any specific problem.

### SUMMARY

Each of the aspects disclosed here may include one or more features described in connection with any of the other disclosed aspects.

Aspects of the present disclosure include a fully or partially-electric machine. The machine may include a machine body and a power system. The machine may include an engine cavity, and the power system may be positioned within the engine cavity. The power system may include a power distribution unit (PDU), one or more batteries, a secondary power source, and one or more motors including a motor. The motor may configured to be operably connected to one or more components of the machine. The PDU may be electrically connected to each of the one or more batteries, the secondary power source, and the motor. The PDU may be configured to receive power from one or more of the secondary power source or the one or more batteries, and provide power to one or more of the first motor and the one or more batteries.

Some aspects of the present disclosure include a fully or partially-electric machine. The machine may include a machine body, a power system, and a central chamber. The machine may include an engine cavity. The power system may be positioned within the engine cavity. The central chamber may divide the engine cavity into a first portion and a second portion. The power system may include a plurality of batteries. Each battery of the plurality of batteries may include a plurality of faces. One or more major faces of the plurality of faces may include a greater area than the remaining faces. The plurality of batteries may include a first battery and a second battery. The one or more major faces of the first battery may be perpendicular to the one or more major faces of the second battery.

Aspects of the present disclosure include a fully or partially-electric machine. The machine may include a machine body and a power system. The machine body may include an engine cavity. The power system may be positioned within the engine cavity of the machine body. The machine may further comprise a mounting assembly fixedly coupled to a rear frame of the machine body. The mounting assembly may include a planar surface. The power system may include a central chamber dividing the engine cavity into a first portion and a second portion. The power system may further include a plurality of batteries and a secondary power source. At least one battery of the plurality of batteries and the secondary power source may be positioned above and supported by the planar surface of the mounting assembly.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is an illustration of an exemplary machine, according to aspects of the disclosure.

FIG. 2A is a perspective view of a power system of the machine of FIG. 1

FIG. 2B is a side view of the power system.

FIG. 2C is a perspective view of the power system.

FIG. 2D is a perspective view of a mounting assembly of the power system.

FIG. 3 is an isolated, perspective view of the mounting assembly.

FIG. 4 depicts a schematic diagram of an electrical system of the power system.

FIG. 5 depicts a schematic diagram of an alternative electrical system of the power system.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

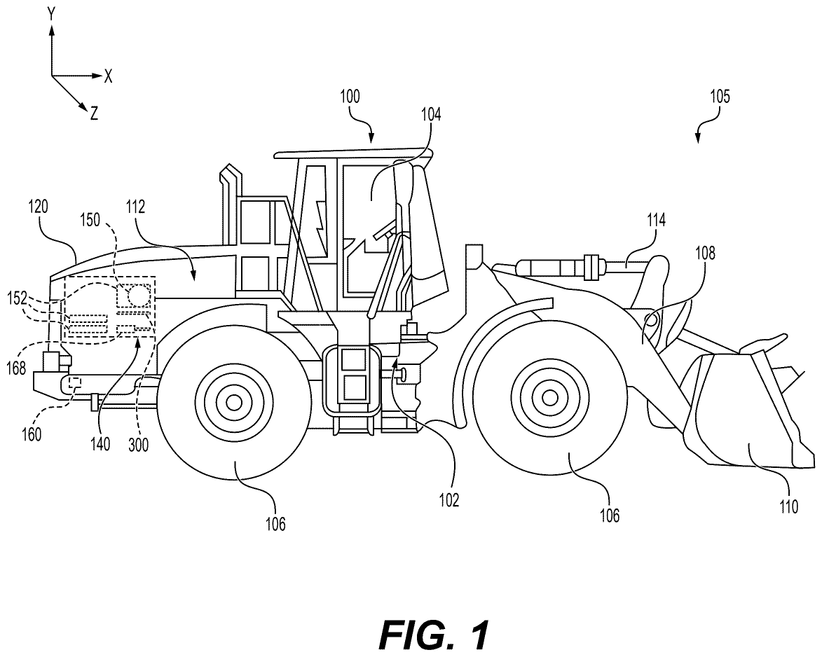

FIG. 1 depicts an exemplary machine, for example, a wheel loader 100, including a plurality of wheels 106. Although the machine depicted in FIG. 1 is a wheel loader, machine 100 may be any of the type of machine or vehicle such as, but not limited to, wheel loaders, excavators, trucks (e.g., dump trucks, haul trucks, articulated dump trucks, etc.), track-type tractors (e.g., bulldozers), graders, continuous miners, feeder breakers, roof bolters, utility vehicles for mining, load-haul-dump (LHD) vehicles, underground mining loaders, underground articulated trucks. Machine 100 may be a vehicle or machine that may be electric or semi-electric (e.g., hybrid, at least partially-electric). Machine 100 includes an X-axis (e.g., rear-to-front, longitudinal, or horizontal), a Y-axis (e.g., top-to-bottom or vertical), and a Z-axis (e.g., side-to-side or lateral). Machine 100 includes a machine body 102, which may include an operator station or cab 104, an engine housing, engine bay, or engine cavity 112 (also referred to herein as cavity 112), and a prime mover or power system 140. In some aspects, machine 100 may be a non-electric machine or vehicle retrofitted to include power system 140 in replacement of, or in addition to, a fuel-burning engine. In some other aspects, machine 100 may be an electric or partially-electric machine or vehicle including power system 140. Retrofitting existing non-electric machines to electric or partially-electric machines provides ecological and environmental benefits, increases fuel efficiency, and increases the expected useful life of existing machines, which potentially would have otherwise been required to be retired or scrapped if retrofitting proved too costly.

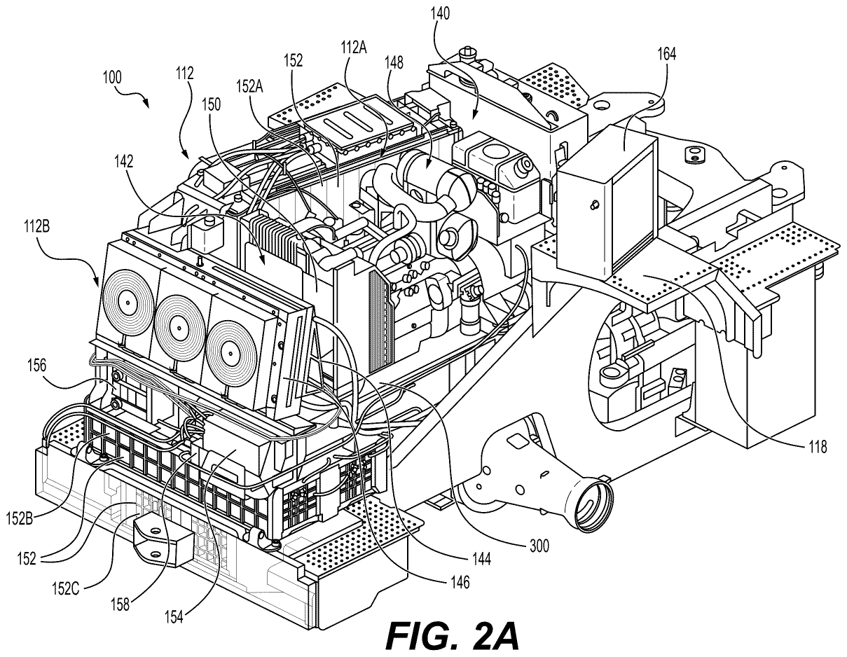

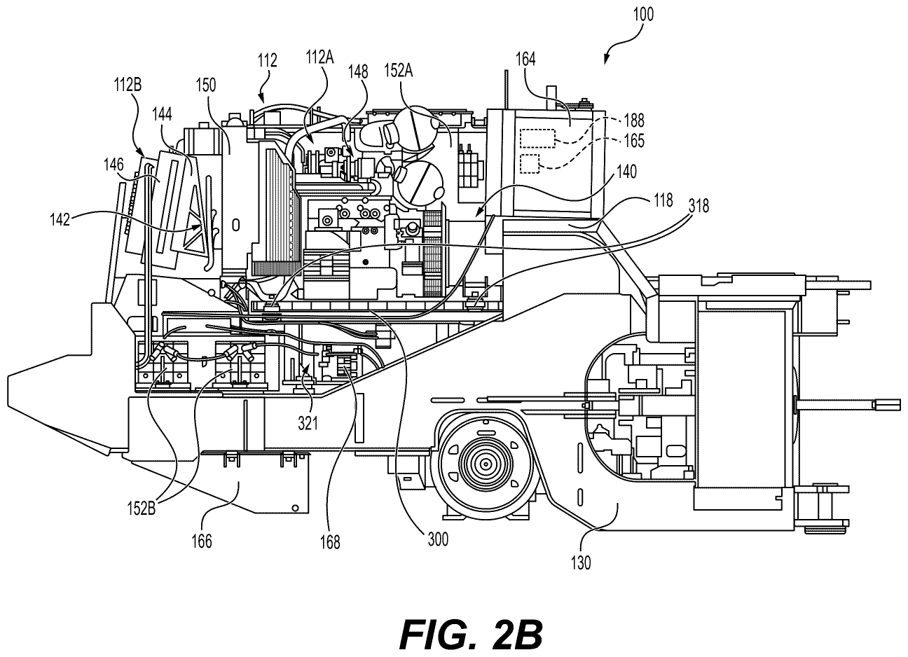

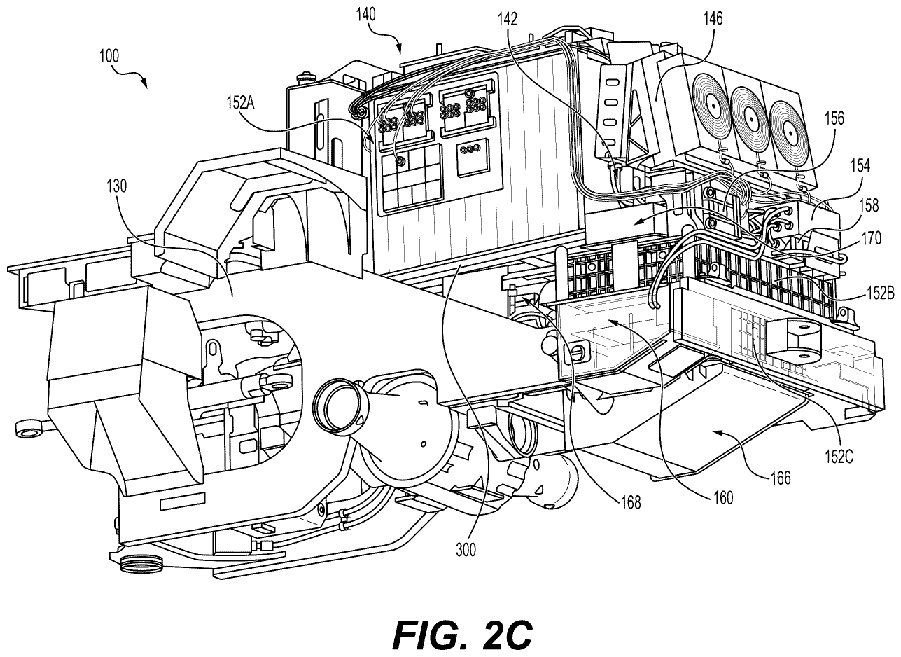

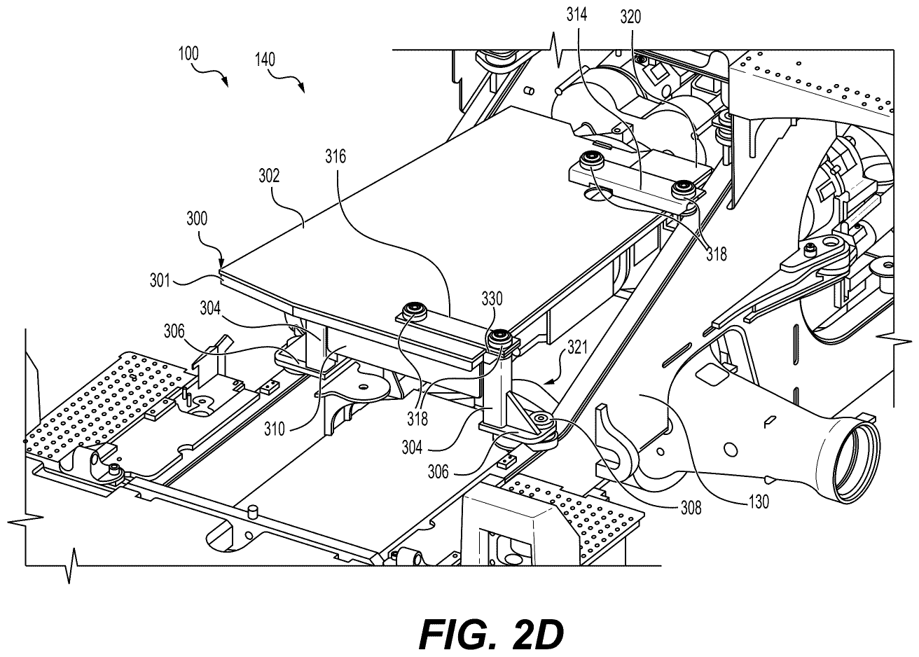

As discussed in detail below, power system 140 includes one or more rechargeable batteries 152 (FIGS. 2A-2B). The one or more batteries 152 may power or energize a motor 168 or other components of machine 100. In some aspects, machine 100 may be fully electric, for example, machine 100 may be fully powered by the one or more batteries 152 of power system 140. In other aspects, machine 100 may be semi-electric (e.g., hybrid), and power system 140 includes a secondary power system, device, or source, for example, an engine, a genset, a fuel cell, etc. The secondary power source may help power or otherwise energize motor 168 to drive wheels 106 or power one or more additional components of machine 100. For example, the secondary power source may be used to recharge batteries 152 during operation of machine 100. Additionally, in some aspects, the one or more batteries 152 may be removable, for example, to be charged away from machine 100, to be easily replaced with one or more charged batteries 152 to extend the work time of machine 100. In other aspects, the one or more batteries 152 may be charged via a charger 160 (e.g., a plug-in charger) during downtime for machine 100.

Machine 100 may include an implement assembly 105. Implement assembly 105 may include one or more arms 108 and a bucket 110 that may be coupled to an end of arm(s) 108. Although not shown, bucket 110 may also be a different work implement, such as a fork, grapple, etc., and, in some aspects, the work implement may be interchangeable. One or more hydraulic arms (e.g., hydraulic arm 114) may be a part of or otherwise coupled to one or more portions of implement assembly 105 to raise and lower arm 108 and bucket 110, and to tilt bucket 110 toward or away from machine 100. Machine 100 may include ground surface engaging devices, such as wheels 106, that support machine body 102 and are powered by the power system 140 (e.g., via motor 168). In another aspect, machine 100 may instead have tracks (not shown).

Power system 140, including one or more batteries 152, may be positioned in a rear portion of machine 100, and, for example, may be positioned in cavity 112. Machine body 102 may include a rear frame 130 (FIG. 2A). One or more components of power system 140, including one or more batteries 152, may be supported by, coupled to (e.g., removably coupled or fixedly coupled), or positioned within or about rear frame 130 or machine body 102. In some aspects of this disclosure, one or more components of power system 140 may be modular, such that one or more components of power system 140 may be installed in various locations within cavity 112 or about machine 100. Machine 100 may further include a hood 120 to cover or enclose power system 140, including one or more batteries 152, within cavity 112.

As shown in FIG. 2A-2D, power system 140 may include a central chamber 142 for receiving inflowing air. Power system 140 may also include a divider 144 within central chamber 142, and divider 144 may be configured to direct some airflow in one direction and direct some airflow in another, different direction. Explained differently, divider 144 or central chamber 142 may divide the cavity 112 into a front portion 112A and a rear portion 112B. For example, divider 144 may direct some airflow toward rear portion 112B of cavity 112 and may direct some airflow toward the front portion 112A of cavity 112. Power system 140 may include a cooling system configured to remove heat from the power system 140 and cavity 112. The cooling system may include a fan cooling system and a liquid cooling system. The fan cooling system may configured to help direct or promote air flow across or around various portions of power system 140, which may help to remove heat from the power system 140 and cavity 112 (e.g., helping to cool power system 140 and cavity 112. The fan cooling system may interact with the liquid cooling system. For example, the liquid cooling system may be configured to remove heat from the power system 140 and cavity 112 and the fan cooling system may be configured to remove heat from (e.g., cool) one or more components of the liquid cooling system.

FIGS. 2A-2C depict the power system 140 within cavity 112, and, in particular, shows the positioning of the components of power system 140 within or relative to front portion 112A and rear portion 112B of the cavity 112. Although specific locations within cavity 112 are discussed below with respect to components of the power system 140, it should be understood that the specific locations are merely exemplary and individual components of power system 140 may be positioned anywhere within or about cavity 112 or machine body 102.

As shown in FIGS. 2A-2C, power system 140 may include a secondary power source, for example, a genset 148 (e.g., a generator and an engine). Genset 148 may include or otherwise be coupled to a radiator 150. Radiator 150 may be fixedly attached to and supported by genset 148. Genset 148 and radiator 150 may be positioned within front portion 112A of cavity 112. Radiator 150 may be positioned to the rear of genset 148. The genset 148 may be a diesel-burning genset, a gasoline-burning genset, a propane-burning genset, or a natural gas-burning genset. Although, the secondary power source is discussed as genset 148, in other aspects, the secondary power source may be a hydrogen powered engine, a fuel cell, or other known power systems.

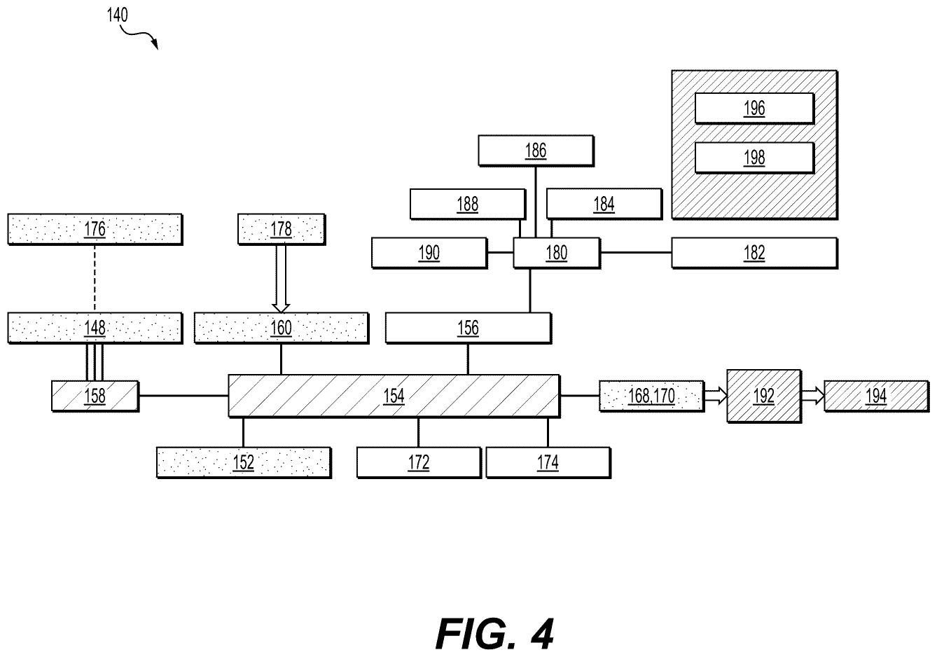

FIGS. 2A-2C depict a battery thermal management system (BTMS) 164 of power system 140. BTMS 164 may be configured to regulate temperatures of one or more batteries 152. BTMS 164 may include a chiller 188 and a condenser or radiator 165. As will be discussed below, BTMS 164 may include one or more low-voltage (LV) components, such as chiller 188. Further, referring to FIG. 4, BTMS 164 may further include one or more LV components, such as a coolant control or expansion valve 182, an evaporator 184, and a pump 186. BTMS 164 may include one or more high-voltage (HV) components, such as a compressor 172 (e.g., an electric compressor) and a fan 174 (e.g., an electric fan). One or more of compressor 172, fan 174, coolant control valve 182, evaporator 184, pump 186, or chiller 188 may be components of the cooling system of power system 140. BTMS 164 may be positioned to the front of central chamber 142. In the exemplary embodiment, BTMS 164 may be positioned within front portion 112A, or outside and adjacent to front portion 112A. One or more components of BTMS 164 may be positioned away from one or more other components of BTMS 164. For example, one or more components of BTMS 164 may be positioned within front portion 112A, one or more components of BTMS 164 may be positioned within rear portion 112B, and one or more components may be positioned elsewhere along machine 100. Machine body 102 may include a mount 118 configured to support BTMS 164.

As shown in FIGS. 2A-2C, power system 140 may further include a power electronics module 146. Power electronics module 146 may be positioned within the rear portion 112B of cavity 112. Central chamber 142 and divider 144 may be positioned between (e.g., along X-axis of machine 100) radiator 150 and power electronics module 146.

As shown in FIGS. 2A and 2C, power system 140 may include a power bus or power distribution unit (PDU 154). PDU 154 may be positioned to the rear of central chamber 142. For example, PDU 154 may be positioned within the rear portion 112B of cavity 112. In some aspects, PDU 154 may be positioned below power electronics module 146. PDU 154 may be electrically connected to one or more components of the power system 140 and may be configured to receive and distribute power to one or more components of the power system 140. For example, PDU 154 may be electrically connected to one or more batteries 152 and configured to receive power from and distribute power to the one or more batteries 152. PDU 154 and the electrical connections associated with PDU 154 are discussed in further detail below.

FIGS. 2A and 2C further depict a DC-DC converter 156 of power system 140. Converter 156 may be configured to receive a high voltage direct current from PDU 154 and convert the high voltage direct current to a lower voltage direct current to power lower voltage components of the power system 140. Converter 156 may be positioned to the rear of central chamber 142. For example, converter 156 may be positioned below the power electronics module 146 and within the rear portion 112B of cavity 112.

Power system 140 may include an AC-DC inverter 158 (FIGS. 2A and 2C) configured to receive an alternating current from genset 148. Inverter 158 may convert the alternating current from genset 148 to a direct current and deliver the direct current to the PDU 154. Inverter 158 may be positioned to the rear of central chamber 142. For example, inverter 158 may be positioned below power electronics module 146 and within rear portion 112B of cavity 112.

As shown in FIG. 2C, power system 140 may include a charger 160 (herein referred to as charger 160). Charger 160 may be electrically coupled to electrical vehicle supply equipment 178 (FIG. 4, herein referred to as EVSE 178) to receive power from a power grid. Charger 160 may be positioned to the rear of central chamber 142. For example, charger 160 may be positioned within rear portion 112B of cavity 112 and below power electronics module 146. Charger 160 may be configured to provide direct current to PDU 154 while charger 160 is electrically coupled to EVSE 178, and PDU 154 may deliver power to the one or more batteries 152.

Referring now to FIGS. 2B and 2C, power system 140 may include a fuel tank 166. Fuel tank 166 may be configured to provide fuel to power system 140. For example, when machine 100 is being partially powered by one or more batteries 152 or when batteries 152 are discharged, fuel from fuel tank 166 may be delivered to genset 148, or another secondary power source. Fuel tank 166 may be positioned to the rear of central chamber 142. In the exemplary embodiment, fuel tank 166 may be positioned below rear portion 112B of cavity 112.

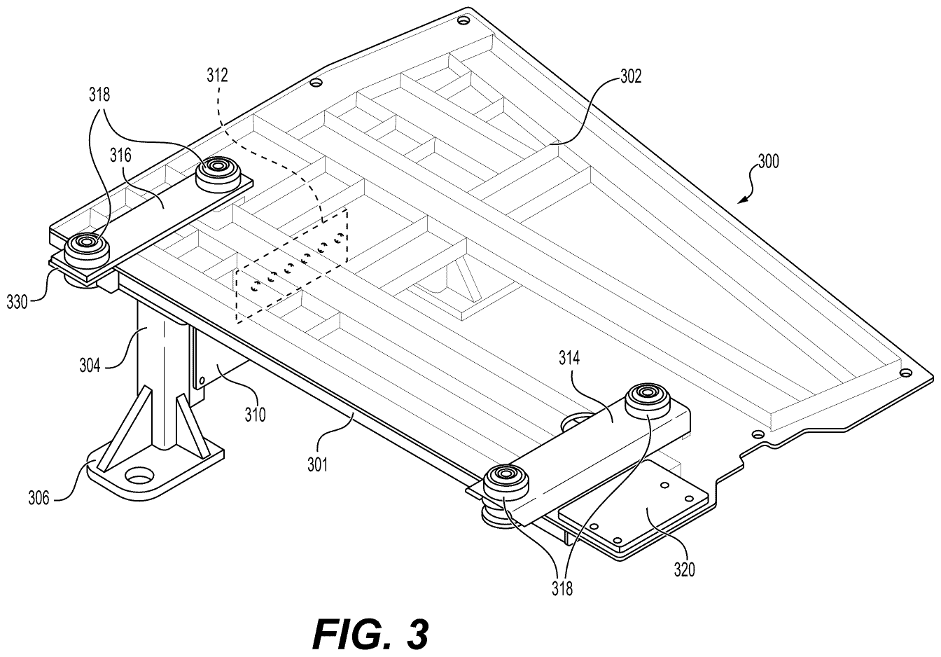

Machine 100 may include a mounting assembly 300. Mounting assembly 300 is depicted within cavity 112 in FIGS. 2A-2D and in isolation in FIG. 3. Mounting assembly 300 may be positioned to the front of central chamber 142. For example, mounting assembly 300 may be positioned within front portion 112A of cavity 112. The mounting assembly 300 may be configured to support one or more components of power system 140. In the exemplary embodiment depicted in FIG. 2B, mounting assembly 300 may be configured to support one or more of batteries 152 and genset 148, for example, including radiator 150. Mounting assembly 300 may be configured to mechanically isolate one or more of batteries 152 or genset 148 from other components within cavity 112. For example, mounting assembly 300 may help to reduce the effect of vibrations, impacts, or twisting on batteries 152 or genset 148. Further, mounting assembly 300 may be coupled (e.g., fixedly or removably attached) to rear frame 130 of machine 100.

Referring now to FIGS. 2D and 3, mounting assembly 300 may include a mounting plate 301 having a top, planar surface 302. Planar surface 302 may include a generally rectangular shape. Planar surface 302 may be parallel or approximately parallel to a horizon (e.g., a ground surface driven on by machine 100). Explained differently, planar surface 302 may be horizontally disposed within cavity 112. Mounting assembly 300 may further include a rear mounting strip 316 (e.g., rear mount) and a front mounting strip 314 (e.g., front mount). Each of strips 314, 316 may be fixedly attached to planar surface 302. For example, strips 314, 316 may be welded, fastened, or otherwise affixed or coupled to planar surface 302. Rear mounting strip 314 may be welded to planar surface 302, and front mounting strip 316 may be fastened to planar surface 302 via one or more fasteners. Fastening front mounting strip 314 (e.g., instead of welding), may allow mounting strip 314 to be adjusted or moved to be compatible with genset 148 or other secondary power sources. Strips 314, 316 may be positioned on or about planar surface 302, such that strips 314, 316 are aligned with one or more mounting points of genset 148. Accordingly, depending on the specifications and dimensions of genset 148, or other secondary power sources, strips 314, 316 may be positioned at different locations on or about planar surface 302.

Front mounting strip 314 may include one or more side walls. A planar surface of front mounting strip 314 may be connected to top ends of the one or more side walls such that the planar surface is positioned further above the planar surface 302 than a planar surface of rear mounting strip 316. Mounting strips 314, 316 may be positioned along a longitudinal side of planar surface 302 or a side of planar surface 302 parallel or approximately parallel to the X-axis of machine 100. Each of mounting strips 314, 316 may be fastened or otherwise coupled to planar surface 302 via one or more fasteners. For example, each mounting strip 314, 316 may be fastened to planar surface 302 at a first longitudinal end and a second longitudinal end of respective mounting strip 314, 316. Each of mounting strips 314, 316 may include one or more dampers 318 (e.g., isolation mounts) extending upward from respective mounting strip 314, 316. Each of mounting strips 314, 316 may include a damper 318 at the first and second longitudinal ends of respective mounting strips 314, 316. In some aspects, one or more dampers 318 may be coupled to the fasteners of mounting strips 314, 316. Each damper 318 may include a first portion above the respective mounting strip 314, 316 and a second portion below the respective mounting strip 314, 316. At least one damper 318 of front mounting strip 314 may contact rear frame 130. During operation, one or more dampers 318 may contact genset 148 and may be configured to reduce vibrations produced by or received by genset 148. As shown in FIG. 2B, genset 148 may be fastened to one or more fasteners of mounting strips 314, 316, and by extension, fastened to mounting assembly 300.

Mounting assembly 300 may further include one or more supports or legs 304 positioned at a rear end of planar surface 302. In the exemplary embodiment, mounting assembly 300 may include two legs 304. A top end of one leg 304 may be fastened to one or more of planar surface 302 or a longitudinal end of rear mounting strip 316. For example, planar surface 302 may include a planar protrusion or gusset 330 extending outward from planar surface 302 along the Z-axis of machine 100. The top end of the one leg 304 may be fastened to planar surface 302 via gusset 330 and rear mounting strip 316. A top end of the other leg 304 may be fastened to planar surface 302. A bottom end of each leg 304 may include a foot 306. Each foot 306 may be fastened to rear frame 130 via one or more fasteners. Each foot 306 may include one or more dampers 308 (e.g., isolation mounts). Each damper 308 may include a first portion above and a second portion below the respective foot 306. One or more dampers 308 may be coupled to a fastener fastening the respective foot 306 to rear frame 130. Mounting assembly 300 may include a plate 310 extending between and fastened to legs 304. Plate 310 may include a cable organizer 312 including a plurality of apertures, each of which being configured to receive one or more cables, conduits, or wires of power system 140. A front portion of planar surface 302 may include a bracket 320 including a plurality of fastener holes corresponding to, and aligned with, a plurality of holes defined through planar surface 302. The front portion of planar surface 302 may be fastened to a portion of machine body 102, such as rear frame 130, by inserting and tightening fasteners through respective holes of the bracket 320 and planar surface 302. Bracket 320 may help to reinforce, stiffen, or stabilize planar surface 302.

Referring back to FIG. 2B, power system 140 may include motor 168. Motor 168 may be positioned to the front of central chamber 142. Mounting assembly 300 may define a space, cavity, or chamber 321 below planar surface 302 configured to receive motor 168. In the exemplary embodiment, motor 168 may be positioned within front portion 112A of cavity 112 within chamber 321. Further, motor 168 may be electrically connected to a motor inverter 170. In some aspects, chamber 321 may be configured to receive or otherwise accommodate at least portions of one or more of motor 168, motor inventor 170, coupling (e.g., a coupling 192), a transmission (e.g., a transmission 194), a gear box, or other component of power system 140. According to some aspects, power system 140 may include a plurality of motors 168. For example, power system 140 may include one motor 168 for driving transmission 194 of machine 100 and another motor 168 for driving other components of machine 100, such as brakes, hydraulics, steering, or accessory devices. According to some aspects, power system 140 may include a gearbox coupled to an inverter and having appropriate connections to transmission 194 of machine 100.

Referring now to FIGS. 2A-2C, as discussed above, power system 140 may include one or more batteries 152. Each battery 152 may be modular and may include a plurality of battery cells (e.g., a battery string). Furthermore, each battery 152 may include a rectangular prism shape, however, this is merely exemplary and each battery 152 may include any shape. Each battery 152 may include a length (e.g., a major dimension), a width (e.g., an intermediate dimension), and a depth (e.g., a minor dimension). One or more batteries 152 may include a first battery 152A positioned to the front of central chamber 142. For example, first battery 152A may be positioned within the front portion 112A of cavity 112. Further, first battery 152A may be positioned on or supported by the planar surface 302 of mounting assembly 300. Positioning first battery 152A on planar surface 302 may help to isolate first battery 152A from damage resulting from twisting of machine body 102 or articulation of machine body 102 about an axle, impacts, vibrations, etc. According to some aspects of the disclosure, first battery 152A may be fastened to mounting assembly 300. First battery 152A may be oriented within front portion 112A such that one of the length or width of first battery 152A is parallel to the X-axis of machine 100 and the other of the length or width of first battery 152A is parallel to the Z-axis of machine 100. In other words, a major (e.g., greatest surface area) face of first battery 152A defined by the length and width of first battery 152A may be vertically disposed within front portion 112A of cavity 112. The disclosed orientation of first battery 152A may allow for first battery 152A to be received within rear frame 130 or within front portion 112A of cavity 112. Further, as depicted in FIG. 2A, the genset 148 may be positioned adjacent to the major face of first battery 152A.

One or more batteries 152 may further include a second battery 152B and a third battery 152C. Second battery 152B and third battery 152C may be positioned away from first battery 152A within cavity 112. For example, second and third batteries 152B, 152C may be positioned below or directly below central chamber 142. Further, as depicted in FIG. 2B, second and third batteries 152B, 152C may be positioned below planar surface 302 of mounting assembly, relative to the Y-axis of machine 100. One or more of batteries 152B, 152C may extend through rear portion 112B and front portion 112A of cavity 112. Second and third batteries 152B, 152C may be oriented differently within cavity 112 than first battery 152A. For example, one of the length and width of respective batteries 152B, 152C may be parallel to the X-axis of machine 100 and the other of the length and width of respective batteries 152B, 152C may be parallel to the Y-axis of machine 100. Described differently, each of second and third batteries 152B, 152C may be horizontally disposed within cavity 112. Relative to one another, second and third batteries 152B, 152C may be positioned such that a major face of the second battery 152B is facing or adjacent to a major face of the third battery 152C. Third battery 152C may be positioned below the second battery 152B. Further, the major face of the second battery 152B and the major face of the third battery 152C may be parallel or approximately parallel to one another. According to some aspects, batteries 152A, 152B, 152C may be positioned within cavity 112 or about machine body 102, such that batteries 152A, 152B, 152C are less likely to be damaged by a twisting or articulation of one or more portions of machine 100, such as during articulation of an axle of machine 100.

FIG. 4 depicts a schematic diagram of an electrical system of power system 140. The electrical system may include one or more electrical connections between one or more components of power system 140. For example, the electrical system may include one or more electrical connections between one or more components of power system 140 depicted in FIGS. 1-2D and one or more components of power system 140 omitted from FIGS. 1-2D. For example, power system 140 may further include a low-voltage system 180 (herein LV system 180). LV system 180 may be electrically connected to and configured to distribute low-voltage, direct current one or more components of power system 140. LV system 180 may be electrically connected to one or more components of BTMS 164 such as coolant control valve 182, evaporator 184, and pump 186, and chiller 188. LV system 180 may include a battery 190, and may further include electrical connections to a battery 190. Battery 190 may be a 24V battery, and battery 190 may be used to power one or more components (e.g., auxiliary components) of machine 100. LV system 180 may be electrically connected to and configured to distribute power (e.g., low-voltage, direct current) to each of coolant control valve 182, evaporator 184, pump 186, chiller 188, and battery 190. In an exemplary embodiment, LV system 180 may be configured to provide approximately 8.5 kW of power to each of coolant control valve 182, evaporator 184, pump 186, and chiller 188. Further, LV system 180 may be configured to receive power from or provide charge to battery 190. Power system 140 may include a display 196 having a user interface. For example, display 196 may include a user interface for an operator to control or monitor one or more aspects or components of power system 140. Power system 140 may further include a ground fault detection device (GFD) 198.

The power distribution unit (PDU 154) may include electrical connections to one or more components of power system 140. In the exemplary embodiment of the electrical system depicted in FIG. 4, genset 148 may provide power to PDU 154 during operation of machine 100. Genset 148 may be electrically connected to AC-DC inverter 158. Genset 148 may be configured to provide alternating current to inverter 158 via a three-phase connection. For example, genset 148 may be configured to provide power of 480V, 110A, 55 kW to inverter 158. The electrical connection between genset 148 and inverter 158 may be a three-phase connection. Inverter 158 may be electrically connected to PDU 154. Inverter 158 may convert the alternating current and power provided by genset 148 and provide a direct current and voltage of 750V to PDU 154. One or more batteries 176, such as 12V batteries, may be electrically connected to genset 148 and configured to provide power to or receive charge from genset 148.

Charger 160 may be electrically couplable to electrical vehicle supply equipment 178 (EVSE 178) to receive power from a power grid. For example, charger 160 may receive power from the power grid while electrically coupled to EVSE 178. EVSE 178 may provide a voltage in the range of about 360 root-mean-square voltage (Vrms) to about 530 Vrms. EVSE 178 may provide alternating or direct current to charger 160. In embodiments, where EVSE 178 provides alternating current, power system 140 may include an inverter for converting the alternating current to direct current. Charger 160 may be electrically connected to PDU 154 and configured to provide power (e.g., direct current and a voltage of 750V) to PDU 154. Charger 160 may include one or more of an inverter or a converter.

Each battery (e.g., batteries 152A, 152B, and 152C) of the one or more batteries 152 may be electrically connected to PDU 154. Batteries 152 may receive power from PDU 154, and batteries 152 may also provide power to PDU 154. For example, batteries 152 may receive power (e.g., direct current and voltage of 750V) from PDU 154.. Conversely, batteries 152 may provide power (e.g., direct current and voltage of 750V) to PDU 154. Batteries 152 may receive charge (e.g., power) via a first charging path or a second charging path. In the first charging path, power may flow from genset 148, to inverter 158, to PDU 154, and then to batteries 152. Batteries 152 may be charged via the first charging path when the machine 100 is in an operating state. In the second charging path, power may flow from the power grid, to EVSE 178, to charger 160, to PDU 154, and then to batteries 152. Batteries 152 may be charged via the second charging path when machine is in a non-operating state.

Motor inverter 170 may be electrically connected to PDU 154. PDU 154 may be configured to provide power (e.g., a direct current and voltage of 750V) to motor inverter 170. Motor inverter 170 may convert the direct current to an alternating current and provide an alternating current and power to motor 168. As shown in FIG. 4, motor 168 may be operably coupled to a transmission 194 of machine 100 via a coupler/coupling 192.

Converter 156 may be electrically connected to PDU 154. In the exemplary embodiment, PDU 154 may be configured to provide power (e.g., direct current and voltage of 750V) to converter 156. As depicted in FIG. 4, converter 156 may be electrically connected with LV system 180. Converter 156 may be configured to convert the voltage of 750V provided by PDU 154 to a lower voltage, such as 24V, and provide the lower voltage charge to LV system 180. LV system 180 may provide or distribute power to each of or one or more of coolant control valve 182, evaporator 184, pump 186, chiller 188, or battery 190. Further, LV system 180 may receive a power (e.g., direct current and voltage of 24V) from battery 190, for example, via PDU 154.

PDU 154 may be electrically connected to one or more components of the cooling system or HV components or systems. For example, PDU 154 may be electrically connected to compressor 172 and configured to provide power (e.g., direct current and voltage of 750V) to compressor 172. Further, PDU 154 may be electrically connected to fan 174 and configured to provide power (e.g., direct current and voltage of 750V) to fan 174.

In these aspects, PDU 154 may be configured to receive power from genset 148 via inverter 158. PDU 154 may provide charge to one or more batteries 152, and PDU may distribute power to one or more of motor 168 via motor inverter 170, compressor 172, fan 174, LV system 180, and to motor 168 via motor inverter 170. Further, PDU 154 may receive power from one or more batteries 152 or genset 148 via inverter 158, and PDU may distribute power to one or more of motor 168 via motor inverter 170, compressor 172, fan 174, LV system 180, and to motor 168 via motor inverter 170.

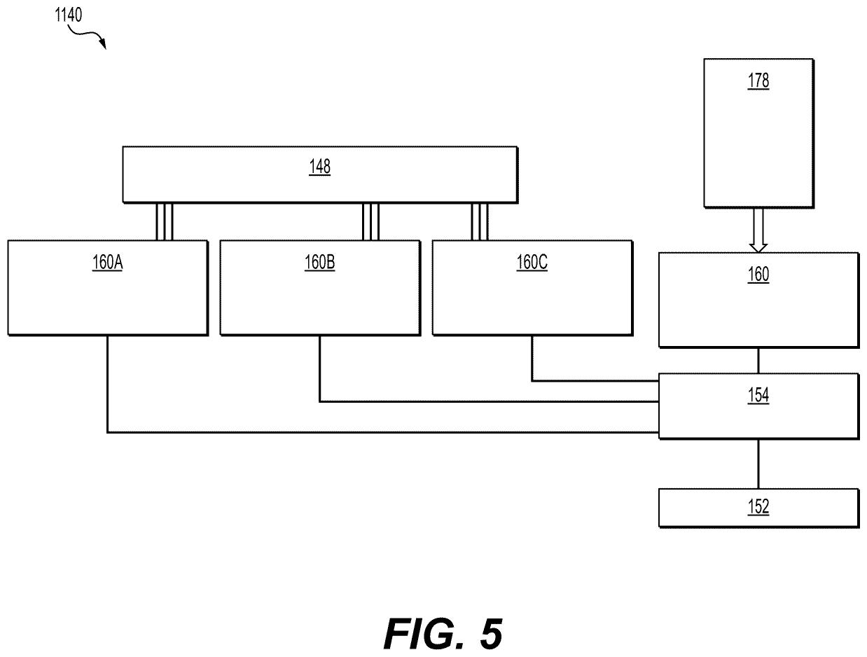

FIG. 5 depicts a portion of an electrical system of an alternative embodiment of power system 140, a power system 1140. Power system 1140, and its electrical system, may be identical to power system 140 except as described. For example, instead of inverter 158, power system 1140 may include a plurality of chargers including a first charger 160A, a second charger 160B, and a third charger 160C. Chargers 160A, 160B, 160C may be substantially identical to charger 160. Chargers 160A, 160B, 160C may be connected in parallel. Genset 148 may be electrically connected to each of chargers 160A, 160B, 160C individually via a three-phase connection as shown in FIG. 5. Genset 148 may provide power (e.g., alternating current of 110A, voltage of 480V, or power of 55 kW) to each of chargers 160A, 160B, 160C. Further, each of chargers 160A, 160B, 160C may be electrically connected to PDU 154 individually. Each of chargers 160A, 160B, 160C may be configured to provide power (e.g., direct current and a charge of 750V) to PDU 154. For example, batteries 152 may be charged via a charging path including chargers 160A, 160B, 160C. Power may flow from genset 148, to chargers 160A, 160B, 160C, to PDU 154, and then to batteries 152.

Still referring to FIG. 5, batteries 152 may receive charge (e.g., power) via a first charging path or a second charging path. In the first charging path, power may flow from genset 148, to each of chargers 160A, 160B, 160C, to PDU 154, and then to batteries 152. Batteries 152 may be charged via the first charging path when the machine 100 is in an operating state. In the second charging path, power may flow from the power grid, to EVSE 178, to charger 160, to PDU 154, and then to batteries 152. Batteries 152 may be charged via the second charging path when machine is in a non-operating state.

### INDUSTRIAL APPLICABILITY

The disclosed aspects of the power system of the present disclosure may be applied to any electric or partially-electric machine or vehicle, such as a semi-electric wheel loader. During operation of an exemplary electric or semi-electric machine (e.g., machine 100), one or more components of a power system 140 provide power to the one or more batteries 152 of power system 140, and one or more components of power system 140 may receive power from the batteries 152. As discussed above, the one or more batteries 152 of power system 140 may be charged via a secondary power source, such as genset 148, while machine 100 is operating, and may be charged via charger 160 while machine 100 is not operating. Further, a mounting assembly 300 can support one or more components of power system 140 or help to isolate said components from other components of power system 140. As discussed, mounting assembly 300 supports one or more of batteries 152 or genset 148. For example, as discussed above, retrofitting existing non-electric machines to electric or partially-electric machines provides ecological and environmental benefits, increases fuel efficiency, and increases the expected useful life of existing machines, which potentially would have otherwise been required to be retired or scrapped if retrofitting proved too costly. Thus, the power system 140 helps to allow for convenient, effective, and cost-effective retrofitting of existing non-electric machines to electric or partially-electric machines.

As discussed above, the power system 140 may allow for machine 100 to utilize one or more batteries 152 during operation to energize motor 168 to, for example, rotate wheels 106. The one or more batteries 152 may receive charge via the power grid which may reduce the environmental impact of machine 100 because a portion of provided by the grid may be generated by renewable energy sources, such as wind and solar power. Accordingly, relying on one or more batteries may reduce emissions, fuel usage, and the overall environmental impact of machine 100. Further, as the secondary power source may be a genset (e.g., genset 148), hydrogen powered engine, a fuel cell, or other known power systems, power system 140 may be installed and retrofitted for in a variety of other machines and vehicles.

The power system 140 may help to increase the uptime (e.g., usage time) of machine 100 because batteries 152 may be slowly charged overnight via charger 160 and then charged during operation via the secondary power source (e.g., genset 148). Compared to fast charging, slowly charging batteries 152 may increase the useful life of batteries 152 and may reduce the impact of charging batteries 152 on the power grid. Furthermore, charging batteries 152 overnight may also reduce the impact on the power grid. Additionally or alternatively, genset 148 may power one or more aspects of machine 100, for example, via PDU 154. In these aspects, genset 148 may charge batteries 152 or may power one or more other aspects of machine 100 (e.g., if batteries are low or depleted), further increasing the uptime (e.g., usage time) of machine 100.

As discussed above, mounting assembly 300 may support or otherwise accommodate one of batteries 152 and the secondary power source (e.g., genset 148). Additionally, mounting assembly 300 may help to isolate batteries 152 and genset 148 from other components of power system 140. Isolating one of batteries 152 from the other batteries 152 may help to reduce vibrations, impacts, the risk of battery twisting, etc. Further, isolating one of batteries 152 and genset 148 from other components of power system 140 may allow power system 140 to be more easily installed and retrofitted into other machines without significant redesign of the machine. The mounting assembly 300 may prevent damage to one or more components of power system 140. For example, dampers 308, 318 may reduce vibrations affecting and caused by genset 148. Mounting assembly 300 may also provide chambers for components of the power system 140, such as motor 168, one or more gear boxes, transmissions, etc., and mounting assembly 300 may help to accommodate or protect such components from damage during operation.

As discussed above, power system 140 may include three, individual batteries 152 (e.g., three battery strings or battery packs). Breaking up the batteries 152 into multiple subsystems (e.g., batteries 152A, 152B, 152C) may also help to allow for power system 140 to be easily installed in view of the available space within an engine cavity of a machine (e.g., retrofitting an existing non-electric machine to be at least partially-electric). Positioning first battery 152A, as discussed above, may help to reduce vibrations, twisting, and impact effects on battery 152A. Moreover, positioning batteries 152A, 152B, 152C, as discussed above in the described positions or orientations, may help to reduce vibrations, twisting, impacts, etc. on one or more of batteries 152A, 152B, 152C, while also helping to accommodate batteries 152A, 152B, 152C within cavity 112. Further, breaking up the batteries 152 allows for individual batteries 152 to be installed in advantageous orientations in other machines and for more batteries 152 (e.g., four or more batteries 152) to be installed within an engine cavity of a machine. For example, the position of batteries 152 within the engine cavity may allow for easy installation, inspection, repair, removal, etc.

As discussed above, one or more components of power system 140 may be modular. For example, the modularity of the one or more components may allow for space within an existing engine bay of a machine to be optimized to receive one or more components of power system 140. Further, the modularity of batteries 152 may help to prevent damage to batteries 152 or power system 140. Each of batteries 152 may be positioned in a location about a machine in which the battery would be less likely to be damaged by twisting or articulation of a frame of the machine about an axle, such as when machine 100 is performing a turn. Thus, the modularity of the one or more components of power system 140 may allow for power system 140 to be more easily installed and retrofitted into other machines without significant redesign.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A fully or partially-electric machine comprising:
a machine body, including an engine cavity; and
a power system positioned within the engine cavity, wherein the power system includes:
a power distribution unit (PDU),
one or more batteries,
a secondary power source, and
one or more motors including a motor, wherein the motor is configured to be operably connected to one or more components of the machine;
wherein the PDU is electrically connected to each of the one or more batteries, the secondary power source, and the motor;
wherein the PDU is configured to receive power from one or more of the secondary power source or the one or more batteries;
wherein the PDU is configured to provide power to one or more of the one or more batteries or the motor.

2. The machine of claim 1, wherein the secondary power source generates power with a gasoline engine, a diesel engine, a natural gas engine, or a hydrogen fuel cell, wherein the motor of the one or more motors is a first motor, wherein the one or more motors includes a second motor, wherein the first motor is operably connected to a transmission of the machine, wherein the second motor is operably connected to another component of the machine.

3. The machine of claim 1, wherein the power system further comprises:
(i) a low voltage (LV) system including one or more components configured to operate at a first voltage; and
(ii) a high voltage (HV) system including one or more components configured to operate at a second voltage, wherein the second voltage is greater than the first voltage;
wherein the PDU is configured to receive power from the one or more batteries and distribute power to the LV system and the HV system.

4. The machine of claim 1, wherein the power system further comprises a charger configured to be electrically connected to a power grid, wherein the charger is electrically connected to the PDU.

5. The machine of claim 4, wherein the one or more batteries are chargeable via a first charging path, wherein the first charging path includes: (i) the secondary power source providing power to the PDU, and (ii) the PDU providing power to the one or more batteries.

6. The machine of claim 5, wherein the one or more batteries are chargeable via a second charging path, wherein the second charging path includes: (i) the charger providing power to the PDU, and (ii) the PDU providing power to the one or more batteries.

7. The machine of claim 6, wherein, during operating periods of the machine, the one or more batteries are charged via the first charging path, and, during non-operating periods of the machine, the one or more batteries are charged via the second charging path.

8. The machine of claim 6, wherein the power system further comprises one or more of a chiller, an evaporator, a pump, or a control valve, wherein, during operation of the machine, the PDU is configured to receive power from the one or more batteries and distribute power to one or more of the chiller, the evaporator, the pump, or the control valve, wherein, during operation of the machine, the PDU is configured to receive power from the secondary power source and distribute power to one or more of the one or more batteries, the chiller, the evaporator, the pump, or the control valve.

9. A fully or partially-electric machine comprising:
a machine body, including an engine cavity; and
a central chamber dividing the engine cavity into a first portion and a second portion;
a power system positioned within the engine cavity, wherein the power system includes a plurality of batteries;
wherein each battery of the plurality of batteries includes a plurality of faces, wherein one or more major faces of the plurality of faces includes a greater area than the remaining faces;
wherein the plurality of batteries includes a first battery and a second battery;
wherein the one or more major faces of the first battery is perpendicular to the one or more major faces of the second battery.

10. The machine of claim 9, further comprising a mounting assembly coupled to the machine body and including a planar surface, wherein the mounting assembly includes one or more isolation mounts, wherein the first battery is positioned above and is supported by the planar surface.

11. The machine of claim 10, wherein the second battery is positioned below the planar surface.

12. The machine of claim 10, wherein the plurality of batteries further includes a third battery, wherein the first battery is positioned within the first portion above the planar surface.

13. The machine of claim 12, wherein the second battery and the third battery are positioned within the engine cavity below the planar surface.

14. The machine of claim 9, wherein the plurality of batteries includes a third battery having a major face parallel to the second battery, wherein the third battery is positioned below the second battery.

15. A fully or partially-electric machine comprising:
a machine body, including an engine cavity;
a mounting assembly fixedly coupled to a rear frame of the machine body, the mounting assembly including a planar surface; and
a power system positioned within the engine cavity, wherein the power system includes:
a central chamber dividing the engine cavity into a first portion and a second portion;
a plurality of batteries, and
a secondary power source;
wherein at least one battery of the plurality of batteries and the secondary power source are positioned above and supported by the planar surface.

16. The machine of claim 15, wherein a rear end of the mounting assembly includes one or more legs fixedly coupled to a rear frame of the machine body.

17. The machine of claim 15, the mounting assembly includes a mount coupled to the planar surface, wherein the mount includes one or more isolation mounts configured to reduce vibrations.

18. The machine of claim 17, wherein one of the one or more isolation mounts includes a first portion above the mount and a second portion below the mount, wherein the second portion contacts the machine body.

19. The machine of claim 16, wherein at least one battery of the plurality of batteries is positioned below the planar surface.

20. The machine of claim 15, wherein the power system further comprises a motor operably coupled to a transmission of the machine, wherein the mounting assembly defines a chamber below the planar surface configured to receive the motor.
